(19) United States
(12) Patent Application Publication
(10) Pub. No.: US 2017/0264768 A1
(43) Pub. Date: Sep. 14, 2017

(54) INFORMATION PROCESSING APPARATUS AND RESTART EXECUTING METHOD

(71) Applicant: Katsumi SAYAMA, Kanagawa (JP)

(72) Inventor: Katsumi SAYAMA, Kanagawa (JP)

(21) Appl. No.: 15/529,134

(22) PCT Filed: Nov. 26, 2015
(86) PCT No.: PCT/JP2015/005882

§ 371 Date: May 24, 2017

(30) Foreign Application Priority Data
Nov. 28, 2014 (JP) 2014-241150
Nov. 24, 2015 (JP) 2015-229111

(51) Int. Cl. H04N 1/00

(52) U.S. Cl. CPC H04N 1/00928; H04N 1/0097; H04N 1/00477; H04N 2201/0091

(57) ABSTRACT

An information processing apparatus includes a setting unit, a storage unit, a determining unit, and a restart executing unit. The setting unit receives a setting of a time to periodically restart the information processing apparatus from a user. The storage unit stores therein the time received by the setting unit and a predetermined condition used for determination of whether to restart the information processing apparatus at the time. At a time of restarting the information processing apparatus at the time stored in the storage unit, the determining unit makes a decision to execute a restart when an operating state of the information processing apparatus meets the predetermined condition stored in the storage unit. The restart executing unit executes the restart in accordance with the decision made by the determining unit.

### TECHNICAL FIELD

The present invention relates to an information processing apparatus and a restart executing method.

### BACKGROUND ART

In Patent Literature 1, there is disclosed an image forming apparatus that is automatically rebooted without a user's operation when a failure is likely to be restored by turning the power off/on.

### SUMMARY OF INVENTION

### Technical Problem

A system reboot in an information processing apparatus is known conventionally; a reboot is performed on the occurrence of an operational malfunction of a system. Furthermore, Patent Literature 1 provides an auto-reboot. However, the conventional technology may reboot a system during execution of a job operation.

Image forming apparatus and the like are usually turned on always to be kept available for use. In that case, a system memory is carelessly consumed, and a malfunction may occur during execution of a job. System reboots performed at appropriate intervals suppress the occurrence of a malfunction. However, if a reboot is performed when the system is running, there is a problem in the point of availability.

The present invention has been made in view of the above circumstances, and an object of the present invention is to suppress a malfunction by executing a system reboot while avoiding a time when the system is running.

### Solution to Problem

According to an embodiment, an information processing apparatus includes a setting unit, a storage unit, a determining unit, and a restart executing unit. The setting unit receives a setting of a time to periodically restart the information processing apparatus from a user. The storage unit stores therein the time received by the setting unit and a predetermined condition used for determination of whether to restart the information processing apparatus at the time. At a time of restarting the information processing apparatus at the time stored in the storage unit, the determining unit makes a decision to execute a restart when an operating state of the information processing apparatus meets the predetermined condition stored in the storage unit. The restart executing unit executes the restart in accordance with the decision made by the determining unit.

### Advantageous Effects of Invention

According to the present invention, it is possible to suppress a malfunction by executing a system reboot while avoiding a time when the system is running.

### BRIEF DESCRIPTION OF DRAWINGS

FIG. 1 is a diagram illustrating a hardware configuration of an information processing apparatus according to a first embodiment.

FIG. 2 is a block diagram illustrating a functional configuration of the information processing apparatus according to the first embodiment.

FIG. 3 is a state transition diagram of the information processing apparatus according to the first embodiment.

FIG. 4 is an example of a display screen at the time of performing a scheduled reboot setting according to the first embodiment.

FIG. 5 is a flowchart of a scheduled reboot operation according to the first embodiment.

FIG. 6 is a display screen transition diagram at the time of execution of the scheduled reboot operation according to the first embodiment.

FIG. 7 is a flowchart illustrating the flow of an energy-saving determining process in an information processing apparatus according to a second embodiment.

FIG. 8 is a flowchart illustrating the flow of an energy-saving determining process in an information processing apparatus according to a third embodiment.

FIG. 9 is a flowchart illustrating the flow of an energy-saving determining process in an information processing apparatus according to a fourth embodiment.

FIG. 10 is a flowchart illustrating the flow of an energy-saving determining process in an information processing apparatus according to a fifth embodiment.

### DESCRIPTION OF EMBODIMENTS

### First Embodiment

Configuration

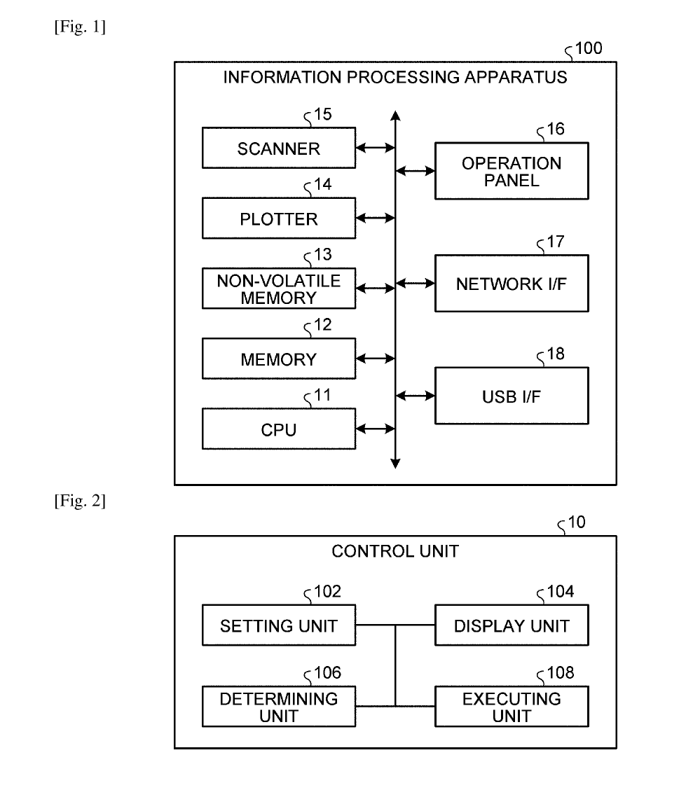

FIG. 1 is a diagram illustrating a hardware configuration of an information processing apparatus according to a first embodiment. An information processing apparatus 100 according to the first embodiment has a configuration in which a CPU 11 as a central processing unit, a memory 12, a non-volatile memory 13, a plotter 14, a scanner 15, an operation panel 16, a network interface (I/F) 17, and a USB interface (I/F) 18 are connected by an internal bus.

The memory 12 is a volatile storage device that serves as a working memory of the CPU 11. The non-volatile memory 13 is a non-volatile storage device in which memory content is held even when the power to the apparatus is turned off. The plotter 14 is an image forming unit for outputting an image including characters onto a paper medium. The scanner 15 is an image reading unit for reading an image from a paper medium or the like with a photoelectric conversion element etc. and converting the read image into electronic data. The plotter 14 and the scanner 15 are referred to as an engine unit.

The operation panel 16 is an electrostatic capacitive type touch panel or the like, and serves as a display unit for showing display data to a user and also serves as a setting unit for receiving an operation input or setting input performed by the user. The network interface 17 is an interface that can communicate with another apparatus or a network host such as a router. The USB interface 18 is an interface with peripherals.

FIG. 2 is a block diagram illustrating a functional configuration of the information processing apparatus according to the first embodiment. As illustrated in FIG. 2, a control unit 10 of the information processing apparatus 100 according to the present embodiment includes a setting unit 102, a display unit 104, a determining unit 106, and an executing unit 108.

The units in the control unit 10 of the information processing apparatus 100 according to the first embodiment are implemented, by the CPU 11, by reading or downloading a software program stored in the non-volatile memory 13 or a network host etc. to the memory 12 and executing the software program by using the hardware illustrated in FIG. 1.

The setting unit 102 receives a setting of a time to periodically restart the information processing apparatus 100 from the user. The received time is stored in a storage device such as the non-volatile memory 13.

The display unit 104 displays a variety of information, screens, etc. on the operation panel 16. Specifically, after the executing unit 108 has executed the restart of the information processing apparatus 100, the display unit 104 displays a user confirmation screen informing the user that the restart has been executed (see FIG. 6). Furthermore, before the determining unit 106 determines whether the operating state of the information processing apparatus 100 meets a predetermined condition, the display unit 104 displays a user confirmation screen informing the user that the restart will be executed shortly.

At the time when the information processing apparatus 100 is restarted at the time stored in the storage device, the determining unit 106 determines whether or not to execute the restart according to the operating state of the information processing apparatus 100 according to whether the operating state meets a predetermined condition stored in the storage device, according to the setting stored the storage device, and/or an operation made by the user, etc.

The executing unit 108 executes the restart of the information processing apparatus 100 in accordance with determination by the determining unit 106. Incidentally, the executing unit 108 serves as a restart executing unit.

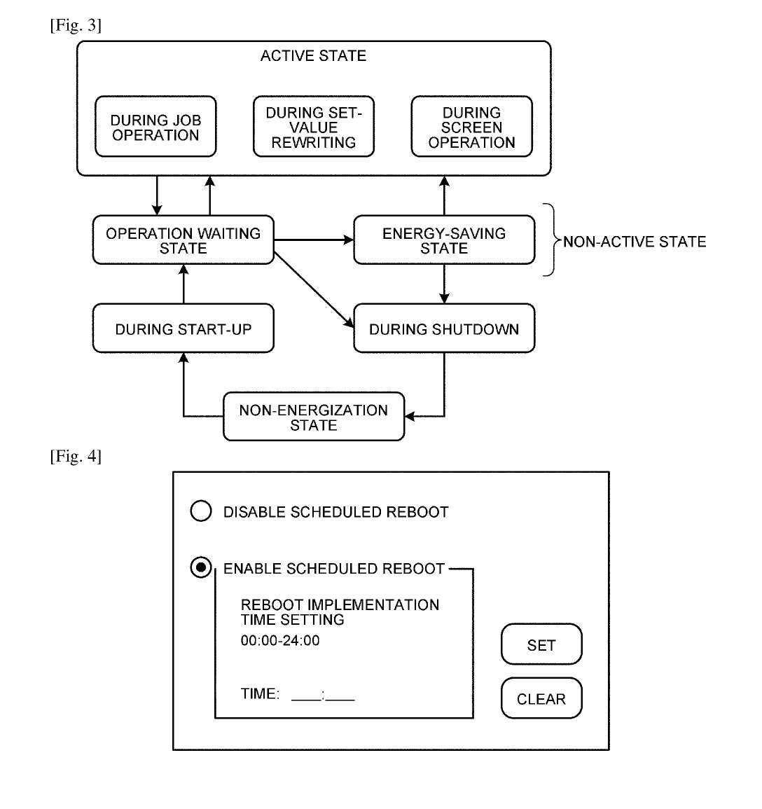

FIG. 3 is a state transition diagram of the information processing apparatus 100 according to the first embodiment. FIG. 3 schematically illustrates an example of states of the apparatus associated with a scheduled reboot operation according to the first embodiment, and there may be any other states as well. As illustrated in FIG. 3, the apparatus operating states of the information processing apparatus 100 broadly include “non-energization state”, “non-active state”, and “active state”.

The “non-energization state” denotes apparatus's power-off state or any equivalent state, and means a state in which the system is shut down. The apparatus is started by application of power, auto-restart, and the like, and makes the transition from the non-energization state to the non-active state in principle.

The “non-active state” is a state of waiting for a user's operation or an energy-saving state. In the first embodiment, the operation waiting state is assumed as a state in which all the blocks illustrated in FIG. 1 are powered on and become available. The energy-saving state is assumed as a state in which the engine unit (the plotter 14 and the scanner 15) and the operation panel 16 are turned off.

The “active state” means a state in which the information processing apparatus 100 is in operation, and includes, for example, states such as during job operation, during set-value rewriting, and during screen operation. During job operation means a state in which the engine unit is working, etc. During set-value rewriting means a state in which a variety of set values stored in the non-volatile memory 13 are being rewritten. This includes those performed by a user's operation and by a remote command, etc. During screen operation means a state in which the user is performing an operation input to the information processing apparatus 100 through the operation panel 16 and the operation panel 16 is receiving the operation input.

Scheduled Reboot Setting

A scheduled reboot setting is required prior to the scheduled reboot operation. The user performs the setting through the operation panel 16 or an external device. The CPU 11 provides an interface for the scheduled reboot setting to the operation panel 16 or the external device.

FIG. 4 is an example of a display screen for performing the scheduled reboot setting according to the first embodiment. Setting items for the scheduled reboot setting include a setting of whether or not to execute the scheduled reboot operation, i.e., a scheduled reboot enable/disable setting. Furthermore, the setting items include a set time. The set time can be set at any time from 00:00 to 24:00. The user can designate a time when the system rarely performs a normal job operation etc.

The non-volatile memory 13 stores therein the scheduled reboot setting including the “set time” and the “scheduled reboot enable/disable setting”. Furthermore, the volatile memory 13 also stores therein a condition (a predetermined condition) to be a basis for determination in an after-mentioned process of determining whether or not to decide on execution of a scheduled reboot to be explained below.

Scheduled Reboot Operation

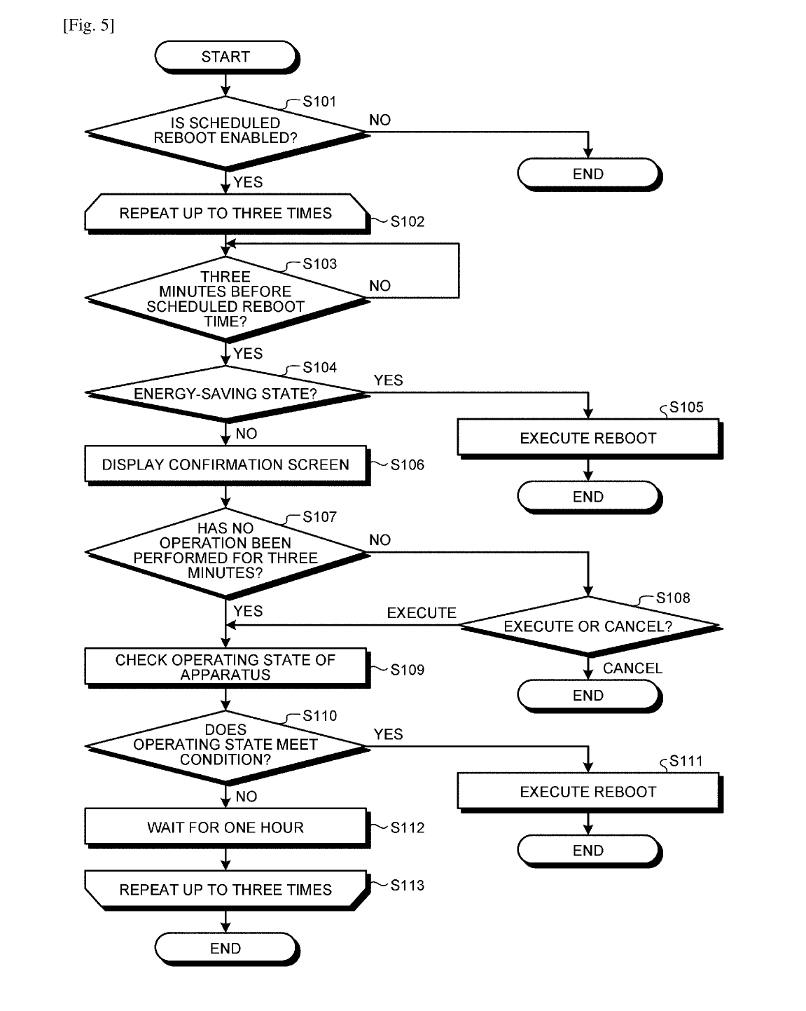

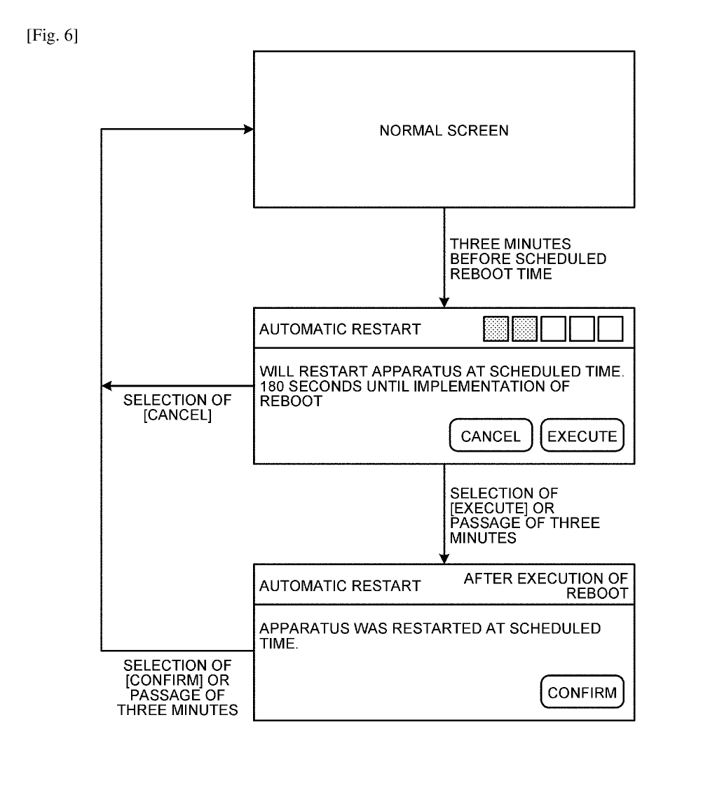

FIG. 5 is a flowchart of the scheduled reboot operation according to the first embodiment. The flowchart illustrated in FIG. 5 is an example of a flowchart of the scheduled reboot operation, and various variations can be implemented.

In the flowchart illustrated in FIG. 5, first, the determining unit 106 checks the scheduled reboot enable/disable setting (Step S101). That is, the determining unit 106 determines whether the scheduled reboot setting, which is one of setting items for the scheduled reboot setting stored in the non-volatile memory 13, is enabled or not. When the determining unit 106 has confirmed that the “scheduled reboot enable/disable setting” is “disable” (NO at Step S101), an auto-reboot is not executed at the set scheduled reboot time. On the other hand, when the determining unit 106 has confirmed that the “scheduled reboot enable/disable setting” is “enable” (YES at Step S101), an auto-reboot is executed when the set scheduled reboot time has come while the apparatus is in power-on state.

When a reboot has been executed (S105, S111), or when a reboot has not been executed even after a reboot retry was repeated several times (twice in the present example) (exit a loop at S113), or when cancellation of a reboot has been explicitly instructed by the user (CANCEL at Step S108), the scheduled reboot operation is terminated.

If a reboot is executed when the system is running, there is a problem in the point of availability. Accordingly, in the first embodiment, the determining unit 106 checks the apparatus operating state just before the execution of a reboot and, only if there is no problem, an auto-reboot is executed. If there is any problem, a reboot is retried after a while. Therefore, Steps S102 to S113 are a loop, and the retry is repeated up to two times. Therefore, a total of three retries can be made.

As operation before the execution of a reboot, just before (in the present example, three minutes before) the scheduled reboot time set by the user (YES at Step S103), the determining unit 106 determines whether the apparatus operating state is the energy-saving state or not (Step S104). When it is not the energy-saving state (NO at Step S104), the display unit 104 displays a user confirmation screen on the operation panel 16 (Step S106). Wait for user's confirmation until the scheduled reboot time (in the present example, for three minutes) (Step S107).

On the other hand, when the determining unit 106 has determined that a condition which is “the information processing apparatus 100 is in the energy-saving state” is met (YES at Step S104), the determining unit 106 decides on execution of a reboot, and the executing unit 108 executes a reboot at the set time in accordance with this decision (Step S105).

Here, user confirmation screens are explained. FIG. 6 is a display screen transition diagram at the time of execution of the scheduled reboot operation according to the first embodiment. The middle display screen in FIG. 6 is a user confirmation screen, and the user confirmation screen is provided with an “EXECUTE” button and a “CANCEL” button. When the user has selected “EXECUTE”, a reboot is executed (EXECUTE at Step S108). On the other hand, when the user has selected “CANCEL”, a reboot is cancelled (CANCEL at Step S108).

When neither option has been selected in three minutes after the display of the user confirmation screen (YES at Step S107), the executing unit 108 executes a reboot. The execution of a job and the change of a set value are not possible while the user confirmation screen is displayed.

Before the execution of a reboot, the determining unit 106 checks the operating state of the information processing apparatus 100 (Step S109). The determining unit 106 determines whether the operating state meets a predetermined condition or not (Step S110), and, if it meets the condition (YES at Step S110), decides on the execution of a reboot, and the executing unit 108 executes a reboot at the set time in accordance with this decision (Step S111). On the other hand, if it does not meet the condition (NO at Step S110), the determining unit 106 waits for a predetermined length of time (in the present example, for one hour) (Step S112) and then retries.

The condition to be a basis for the determination at Step S110 is that the operating state is the “non-active state” illustrated in FIG. 3. On the other hand, when the operating state is the “active state” or during the transition to another state, it is determined that the operating state does not meet the predetermined condition. For example, when the set scheduled reboot time has come, if any of the following conditions is met, a reboot is not executed. Furthermore, the user confirmation screen does not have to be displayed.
During screen operation (for three seconds after a key on the operation unit has pressed)
While the default screen is displayed, During SP mode
Retry operation performed when a reboot is not executed while apparatus is in operation (such as during job operation, during set-value rewriting, during start-up, or during shutdown)

When a reboot has not been executed, a reboot is again retried after one hour. When a reboot has not been executed three times in a row, a reboot is not executed until the next scheduled reboot time. However, in the following cases, a reboot is not executed until the next scheduled reboot time.
When the power is turned off during a period of retry
When the reboot time setting is changed during a period of retry

Incidentally, as an operation after the execution of the reboot, a message that the scheduled reboot was executed is displayed on the operation panel 16 (see the bottom illustration in FIG. 6). In a user confirmation screen after the execution of the reboot in FIG. 6, when the user has selected a “CONFIRM” button on the operation screen before automatic deletion, the display is deleted. Alternatively, the display is automatically deleted. Still alternatively, the display is automatically deleted at the time of the transition to the energy-saving state.

Incidentally, if it is in the energy-saving state, the executing unit 108 executes a reboot at Steps 5104 and 5105. When the scheduled reboot time has come while the information processing apparatus 100 is in the energy-saving state, without the user confirmation screen being displayed, the executing unit 108 executes a reboot.

Furthermore, when scheduled reboot has been executed, the control unit 10 stores information on a reboot history in the non-volatile memory 13. A piece of reboot history information shall be stored, and the latest reboot history is stored. Information to be stored is “a timestamp (a date and time) when the scheduled reboot was executed”.

In the above-described operation, the display screen informing the user of automatic execution is displayed three minutes before the set scheduled reboot time; alternatively, the display screen informing of automatic execution can be displayed at the set scheduled reboot time. In this way, some degree of gap in the timing which will not affect a reboot is allowed.

As described above, in the present embodiment, just before the execution of a scheduled reboot which is automatically executed, whether the operating state of the apparatus meets a predetermined condition is checked (Step S104 or Step S110), and, only if it meets the condition, a reboot is executed; therefore, it is possible to suppress a malfunction by executing a system reboot while avoiding a time when the system is running.

### Second Embodiment

In the first embodiment, whether the information processing apparatus 100 is in the energy-saving state or not is determined, and, if it is in the energy-saving state, a reboot is executed. In a second embodiment, details of the determination of whether the information processing apparatus 100 is in the energy-saving state or not (Step S104 in FIG. 5) will be explained. Incidentally, the configuration and functions of the information processing apparatus 100 are the same as in the first embodiment.

The information processing apparatus 100 according to the second embodiment makes the transition to the energy-saving state when no operation has been performed on the information processing apparatus 100 for a given length of time or when the information processing apparatus 100 is not in operation. Then, when the information processing apparatus 100 has made the transition to the energy-saving state, it is determined that the information processing apparatus 100 is in the non-active state (not yet in operation).

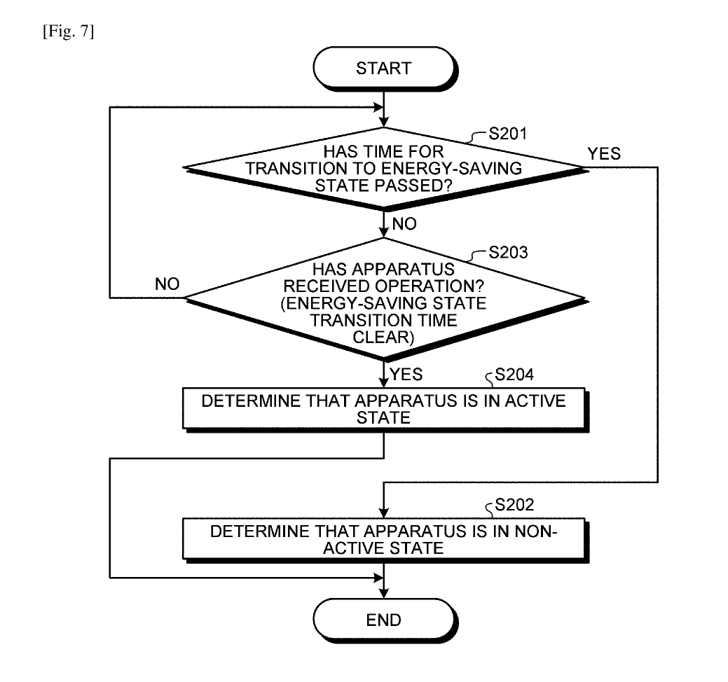

FIG. 7 is a flowchart illustrating the flow of an energy-saving determining process in an information processing apparatus according to the second embodiment. The determining process in FIG. 7 corresponds to Step S104 in FIG. 5.

Just before (in the present example, three minutes before) the scheduled reboot time (Step S103 in FIG. 5), the determining unit 106 determines whether a time for the transition of the information processing apparatus 100 to the energy-saving state has passed or not (Step S201). In the present embodiment, the transition of the information processing apparatus 100 to the energy-saving state is monitored by a timer; when the transition time monitored by the timer has expired, the information processing apparatus 100 goes into the energy-saving state.

That is, when the time for the transition to the energy-saving state has passed (YES at Step S201), the determining unit 106 determines that the information processing apparatus 100 goes into the energy-saving state and is in the non-active state (Step S202). Then, the process moves on to Step S105 in FIG. 5.

On the other hand, when the time for the transition to the energy-saving state has not passed (NO at Step S201), the determining unit 106 determines whether the information processing apparatus 100 has received an operation from a user (Step S203). Then, when the information processing apparatus 100 has received an operation from a user (YES at Step S203), the determining unit 106 determines that the information processing apparatus 100 is in the active state (Step S204). Then, the process moves on to Step S106 in FIG. 5.

On the other hand, when the information processing apparatus 100 has not received an operation from a user (NO at Step S203), returning to Step S201, the process is repeated.

When an operation has been performed on the information processing apparatus 100 while the timer is monitoring just like Step S203, the timer is cleared before the passage of the time for the transition to the energy-saving state (energy-saving state transition time clear), and it is determined that the information processing apparatus 100 is in the active state.

As described above, in the information processing apparatus 100 according to the second embodiment, it is possible to suppress a malfunction by executing a system reboot while avoiding a time when the system is running in the absence of transition to the energy-saving state.

### Third Embodiment

In the first embodiment, whether the operating state of the information processing apparatus 100 meets a condition or not is determined, and, if it meets the condition, a reboot is executed. In a third embodiment, an example of the determination of whether a predetermined condition in the information processing apparatus 100 is met or not (Step S110 in FIG. 5) will be explained in detail. Incidentally, the configuration and functions of the information processing apparatus 100 are the same as in the first embodiment.

The information processing apparatus 100 according to the third embodiment resets a displayed application (also referred to as app) when no operation has been performed on the application for a given length of time. Then, when the information processing apparatus 100 has reset the application, it is determined that the information processing apparatus 100 is in the non-active state (not yet in operation).

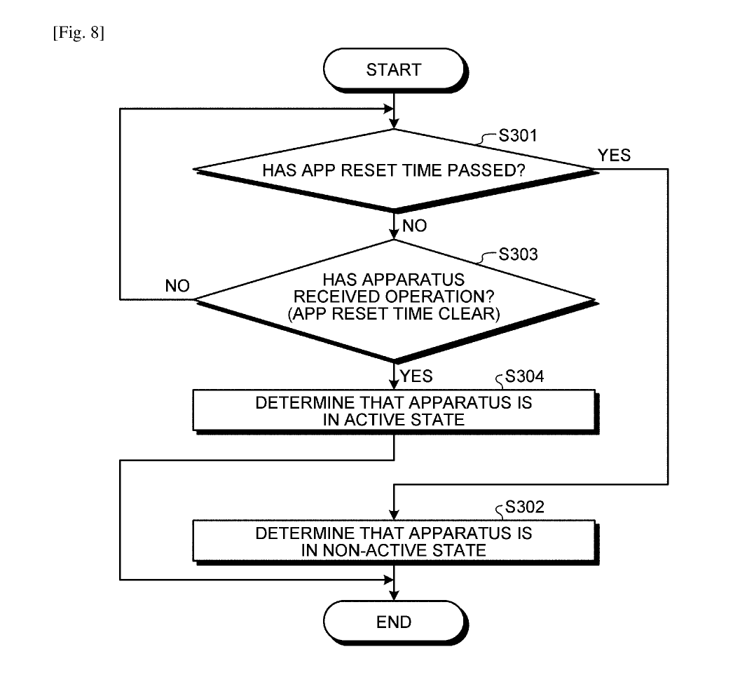

FIG. 8 is a flowchart illustrating the flow of an energy-saving determining process in an information processing apparatus according to the third embodiment. The determining process in FIG. 8 corresponds to Step S110 in FIG. 5.

Before the execution of a reboot, the determining unit 106 checks the operating state of the information processing apparatus 100 (Step S109 in FIG. 5). Then, the determining unit 106 determines whether an app reset time (a time for application reset) of the information processing apparatus 100 has passed (Step S301). In the present embodiment, a time for resetting an application displayed on the operation unit of the information processing apparatus 100 is monitored by a timer; when the app reset time monitored by the timer has expired, the information processing apparatus 100 goes into the non-active state.

That is, when the app reset time has passed (YES at Step S301), the determining unit 106 determines that the information processing apparatus 100 is in the non-active state (Step S302). Then, the process moves on to Step S111 in FIG. 5.

On the other hand, when the app reset time has not passed (NO at Step S301), the determining unit 106 determines whether the information processing apparatus 100 has received an operation from a user (Step S303). Then, when the information processing apparatus 100 has received an operation from a user (YES at Step S303), the determining unit 106 determines that the information processing apparatus 100 is in the active state (Step S304). Then, the process moves on to Step S112 in FIG. 5.

On the other hand, when the information processing apparatus 100 has not received an operation from a user (NO at Step S303), returning to Step S301, the process is repeated.

When an operation has been performed on the information processing apparatus 100 while the timer is monitoring just like Step S303, the timer is cleared before the passage of the time to make the transition to application reset (app reset time clear), and it is determined that the information processing apparatus 100 is in the active state.

As described above, in the information processing apparatus 100 according to the present embodiment, it is possible to suppress a malfunction by executing a system reboot while avoiding a time when the system is running, such as in an operating state in which an operation is being performed on an application.

### Fourth Embodiment

In the first embodiment, whether the operating state of the information processing apparatus 100 meets a condition or not is determined, and, if it meets the condition, a reboot is executed. In a fourth embodiment, another example of the determination of whether a predetermined condition in the information processing apparatus 100 is met or not (Step S110 in FIG. 5) will be explained in detail. Incidentally, the configuration and functions of the information processing apparatus 100 are the same as in the first embodiment.

The information processing apparatus 100 according to the fourth embodiment performs an operation to reset the whole system when no operation has been performed on the information processing apparatus 100 for a given length of time. Then, when the system has been reset, it is determined that the information processing apparatus 100 is in the non-active state (not yet in operation).

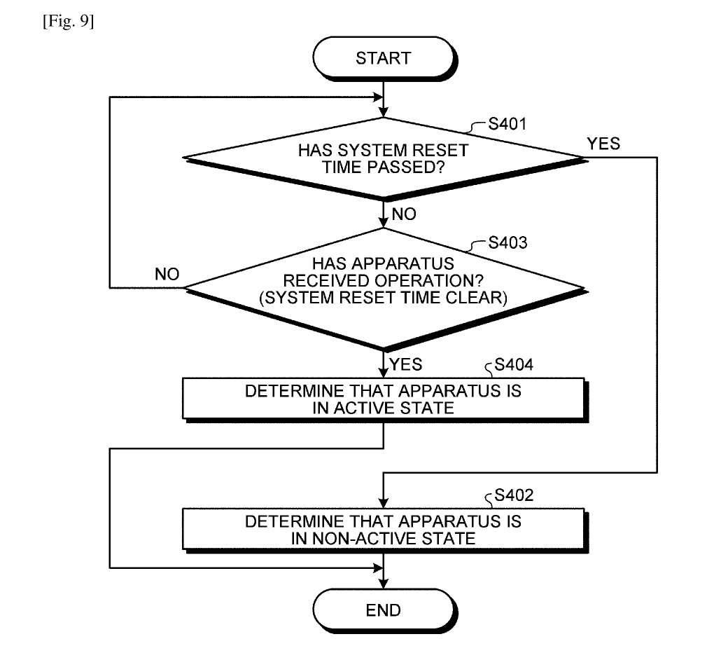

FIG. 9 is a flowchart illustrating the flow of an energy-saving determining process in an information processing apparatus according to the fourth embodiment. The determining process in FIG. 9 corresponds to Step S110 in FIG. 5.

Before the execution of a reboot, the determining unit 106 checks the operating state of the information processing apparatus 100 (Step S109 in FIG. 5). Then, the determining unit 106 determines whether a system reset time (a time for system reset) of the information processing apparatus 100 has passed (Step S401). In the present embodiment, a time for resetting the system of the information processing apparatus 100 is monitored by a timer; when the system reset time monitored by the timer has expired, the information processing apparatus 100 goes into the non-active state.

That is, when the system reset time has passed (YES at Step S401), the determining unit 106 determines that the information processing apparatus 100 is in the non-active state (Step S402). Then, the process moves on to Step S111 in FIG. 5.

On the other hand, when the system reset time has not passed (NO at Step S401), the determining unit 106 determines whether the information processing apparatus 100 has received an operation from a user (Step S403). Then, when the information processing apparatus 100 has received an operation from a user (YES at Step S403), the determining unit 106 determines that the information processing apparatus 100 is in the active state (Step S404). Then, the process moves on to Step S112 in FIG. 5.

On the other hand, when the information processing apparatus 100 has not received an operation from a user (NO at Step S403), returning to Step S401, the process is repeated.

When an operation has been performed on the information processing apparatus 100 while the timer is monitoring just like Step S403, the timer is cleared before the passage of the time to make the transition to system reset (system reset time clear), and it is determined that the information processing apparatus 100 is in the active state.

As described above, in the information processing apparatus 100 according to the present embodiment, it is possible to suppress a malfunction by executing a system reboot while avoiding a time when the system is running, such as in an operating state in which an operation is being performed on the information processing apparatus 100.

### Fifth Embodiment

In the first embodiment, whether the operating state of the information processing apparatus 100 meets a condition or not is determined, and, if it meets the condition, a reboot is executed. In a fifth embodiment, another example of the determination of whether a predetermined condition in the information processing apparatus 100 is met or not (Step S110 in FIG. 5) will be explained in detail. Incidentally, the configuration and functions of the information processing apparatus 100 are the same as in the first embodiment.

The information processing apparatus 100 according to the present embodiment resets a displayed application when no operation has been performed on the application for a given length of time, and performs an operation to reset the whole system when no operation has been performed on the information processing apparatus 100 for a given length of time. Then, when the application has been reset or when the system has been reset, it is determined that the information processing apparatus 100 is in the non-active state (not yet in operation).

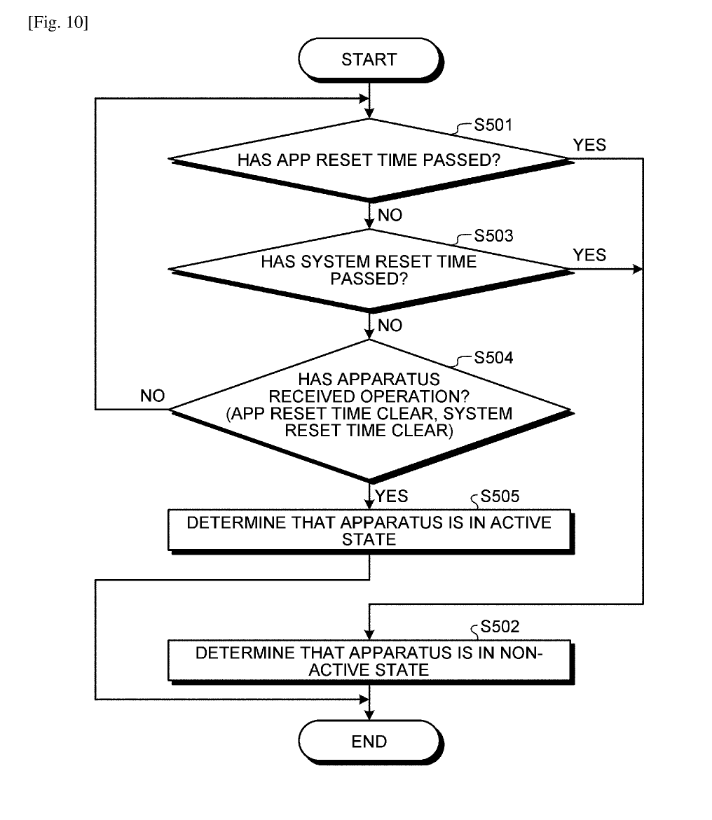

FIG. 10 is a flowchart illustrating the flow of an energy-saving determining process in an information processing apparatus according to the fifth embodiment. The determining process in FIG. 10 corresponds to Step S110 in FIG. 5.

Before the execution of a reboot, the determining unit 106 checks the operating state of the information processing apparatus 100 (Step S109 in FIG. 5). Then, the determining unit 106 determines whether the app reset time of the information processing apparatus 100 has passed (Step S501).

When the app reset time has passed (YES at Step S501), the determining unit 106 determines that the information processing apparatus 100 is in the non-active state (Step S502). Then, the process moves on to Step S111 in FIG. 5.

On the other hand, when the app reset time has not passed (NO at Step S501), the determining unit 106 determines whether the system reset time of the information processing apparatus 100 has passed (Step S503).

When the system reset time has passed (YES at Step S503), the determining unit 106 determines that the information processing apparatus 100 is in the non-active state (Step S502). Then, the process moves on to Step S111 in FIG. 5.

On the other hand, when the system reset time has not passed (NO at Step S503), the determining unit 106 determines whether the information processing apparatus 100 has received an operation from a user (Step S504). Then, when the information processing apparatus 100 has received an operation from a user (YES at Step S504), the determining unit 106 determines that the information processing apparatus 100 is in the active state (Step S505). Then, the process moves on to Step S112 in FIG. 5.

On the other hand, when the information processing apparatus 100 has not received an operation from a user (NO at Step S504), returning to Step S501, the process is repeated.

As described above, in the information processing apparatus 100 according to the fifth embodiment, it is possible to suppress a malfunction by executing a system reboot while avoiding a time when the system is running, such as in an operating state in which an operation is being performed on an application and in an operating state in which an operation is being performed on the information processing apparatus 100.

### Sixth Embodiment

The determination of whether the information processing apparatus 100 is in the energy-saving state or not according to the second embodiment and the determination of whether the operating state of the information processing apparatus 100 meets a condition or not according to the fifth embodiment can be performed in combination.

Accordingly, in the information processing apparatus 100, it is possible to suppress a malfunction by executing a system reboot while avoiding a time when the system is running in the absence of transition to the energy-saving state or a time when the system is running, such as in an operating state in which an operation is being performed on an application and in an operating state in which an operation is being performed on the information processing apparatus 100.

A restart executing program executed by the information processing apparatus 100 according to the present embodiment is provided in such a manner that the program is recorded on a computer-readable recording medium, such as a CD-ROM, a flexible disk (FD), a CD-R, or a digital versatile disk (DVD), in an installable or executable file format.

Furthermore, the restart executing program executed by the information processing apparatus 100 can be provided in such a manner that the program is stored on a computer connected to a network such as the Internet so that the program can be downloaded via the network. Moreover, the restart executing program executed by the information processing apparatus 100 can be provided or distributed via a network such as the Internet. Furthermore, the restart executing program executed by the information processing apparatus 100 can be provided in such a manner that the program is built into a ROM or the like in advance.

The restart executing program executed by the information processing apparatus 100 is composed of modules including the above-described units (the setting unit 102, the display unit 104, the determining unit 106, and the executing unit 108); a CPU (processor) as actual hardware reads out the restart executing program from the above-described storage medium and executes the restart executing program, thereby the above-described units are loaded onto main storage and are generated on the main storage. Furthermore, for example, some or all of the functions of the above-described units can be realized by dedicated hardware circuitry.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

### REFERENCE SIGNS LIST

100 INFORMATION PROCESSING APPARATUS
11 CPU
12 Memory
13 Non-volatile memory
14 Plotter
15 Scanner
16 Operation panel
17 Network interface
18 USB Interface
10 Control unit
102 Setting unit
104 Display unit
106 Determining unit
108 Executing unit

### CITATION LIST

### Patent Literature

PTL 1: Japanese Laid-open Patent Publication No. 2005-219247

1. An information processing apparatus comprising:
a setting unit configured to receive a setting of a time to periodically restart the information processing apparatus from a user;
a storage unit configured to store therein the time received by the setting unit and a predetermined condition used for determination of whether to restart the information processing apparatus at the time;
a determining unit configured to, at a time of restarting the information processing apparatus at the time stored in the storage unit, make a decision to execute a restart when an operating state of the information processing apparatus meets the predetermined condition stored in the storage unit; and
a restart executing unit configured to execute the restart in accordance with the decision made by the determining unit.

2. The information processing apparatus according to claim 1, wherein the predetermined condition includes a condition that the operating state of the information processing apparatus is a non-active state.

3. The information processing apparatus according to claim 1, wherein when the operating state of the information processing apparatus does not meet the predetermined condition, the determining unit repeats determination of whether the operating state of the information processing apparatus meets the predetermined condition stored in the storage unit multiple times at predetermined intervals.

4. The information processing apparatus according to claim 1, wherein
the setting unit is configured to receive a setting of whether to periodically restart the information processing apparatus from the user,
the storage unit stores therein the setting of whether to periodically restart the information processing apparatus, and
the determining unit makes a decision to execute a periodic restart of the information processing apparatus when the setting stored in the storage unit is a setting to periodically restart the information processing apparatus.

5. The information processing apparatus according to claim 1, wherein when the restart executing unit has executed the restart, the storage unit stores therein restart history information which is information on a history of the restart.

6. The information processing apparatus according to claim 1, further comprising a display unit for performing a first display informing the user that the restart has been executed after the restart executing unit has executed the restart.

7. The information processing apparatus according to claim 6, wherein
before the determination by the determining unit of whether the operating state of the information processing apparatus meets the predetermined condition, the display unit performs a second display informing the user that the restart will be executed shortly, and
when the user has performed an operation to urge the restart on the second display, the determining unit makes the decision to execute the restart regardless of the determination by the determining unit of whether the operating state of the information processing apparatus meets the predetermined condition stored in the storage unit.

8. The information processing apparatus according to claim 7, wherein when the operating state of the information processing apparatus is an energy-saving state, the determining unit makes the decision to execute the restart without causing the display unit to perform the second display.

9. An information processing apparatus comprising:
a setting unit configured to receive a setting of a time to periodically restart the information processing apparatus from a user;
a storage unit configured to store therein the time received by the setting unit and a predetermined condition used for determination of whether to restart the information processing apparatus at the time;
a determining unit configured to, at a time of restarting the information processing apparatus at the time stored in the storage unit, make a decision to execute a restart when an operating state of the information processing apparatus does not meet the predetermined condition stored in the storage unit; and
a restart executing unit configured to execute the restart in accordance with the decision made by the determining unit.

10. A restart executing method performed in an information processing apparatus, the restart executing method comprising:
receiving a setting of a time to periodically restart the information processing apparatus from a user;
storing, in a storage unit, the time received at the setting and a predetermined condition used for determination of whether to restart the information processing apparatus at the time;
making, at a time of restarting the information processing apparatus at the time stored in the storage unit, a decision to execute a restart when an operating state of the information processing apparatus meets the predetermined condition stored in the storage unit; and
executing the restart in accordance with the decision made at the determining.
